(19) United States
(12) Patent Application Publication
(10) Pub. No.: US 2025/0208970 A1
(43) Pub. Date: Jun. 26, 2025

(54) METHOD FOR PROTOTYPING AND EVALUATION OF HARDWARE ACCELERATORS

(71) Applicant: SK hynix Inc., Gyeonggi-do (KR)

(72) Inventor: Siarhei ZALIVAKA, Gdansk (PL)

(21) Appl. No.: 18/394,147

(22) Filed: Dec. 22, 2023

(51) Int. Cl. G06F 11/34

(52) U.S. Cl. CPC G06F 11/3428

(57) ABSTRACT

A method for evaluating hardware accelerators in the design flow of the hardware accelerators. The method includes: generating a data processing graph for describing at least one algorithmic operation; evaluating a complexity and performance of the data processing graph using complexity and performance metrics; modifying the data processing graph based on set constraints, and the evaluated complexity and performance to generate multiple data processing graphs; evaluating the multiple data processing graphs using the complexity and performance metrics; and selecting at least one optimal graph from among the multiple data processing graphs for design of the hardware accelerator. The optional part of hardware implementation includes HDL description and FPGA/ASIC synthesis.

### BACKGROUND

### 1. Field

Embodiments of the present disclosure relate to hardware accelerators.

### 2. Description of the Related Art

Nowadays, leading manufacturers of semiconductor devices spend a large amount of material and human resources on the development of systems called hardware accelerators. A hardware accelerator is a specialized processor that is designed to accelerate a specific type of computation. Hardware accelerators are optimized for a particular task or set of tasks, which allows them to perform those tasks faster and more efficiently than general-purpose processors. Some examples of hardware accelerators include graphics processing units (GPUs), digital signal processors (DSPs), and tensor processing units (TPUs). The purpose of such hardware accelerators is to reduce the computational load on the central computing device (e.g., CPU, SSD HOST-controller, etc.) and to increase the performance of the whole semiconductor device.

### SUMMARY

Aspects of the present invention include a method and a system for evaluating hardware accelerators in the design flow of the hardware accelerators for cost reduction in the entire system design.

In one aspect of the present invention, a method for evaluating a hardware accelerator includes: generating a data processing graph for describing at least one algorithmic operation; evaluating a complexity and performance of the data processing graph using complexity and performance metrics; modifying the data processing graph based on set constraints, and the evaluated complexity and performance to generate multiple data processing graphs; evaluating the multiple data processing graphs using the complexity and performance metrics; and selecting at least one optimal graph from among the multiple data processing graphs for design of the hardware accelerator.

In one aspect of the present invention, a system includes a host configured for hardware accelerator development; a storage device; and a hardware accelerator designable by the host and coupled between the host and the storage device. The storage device is configured to store data associated with a calculated performance of the hardware accelerator. The host is configured to: generate a data processing graph for describing at least one algorithmic operation; evaluate a complexity and performance of the data processing graph using complexity and performance metrics; modify the data processing graph based on set constraints, and the evaluated complexity and performance to generate multiple data processing graphs; and evaluate the multiple data processing graphs using the complexity and performance metrics to select at least one optimal graph from among the multiple data processing graphs for design of the hardware accelerator.

Additional aspects of the present invention will become apparent from the following description.

### BRIEF DESCRIPTION OF THE DRAWINGS

FIG. 1 is a data processing system including a hardware accelerator in accordance with one embodiment of the present invention.

FIG. 2 illustrates a design flow for a hardware accelerator in accordance with one embodiment of the present invention.

FIG. 3 is a flowchart illustrating an approach for evaluating a hardware accelerator in accordance with one embodiment of the present invention.

FIG. 4 is a flowchart illustrating primary operations in accordance with one embodiment of the present invention.

FIG. 5 is a flowchart illustrating recommended stages in accordance with one embodiment of the present invention.

FIGS. 6 to 8 illustrate examples of generation and modification of a data processing graph (DPG) in accordance with one embodiment of the present invention.

FIGS. 9A to 9C illustrate hardware description language (HDL) descriptions of data processing graphs (DPGs) shown in FIGS. 6 to 8.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of the embodiments of the present invention is provided below along with accompanying figures that illustrate aspects of the present invention. The present invention is described in connection with such embodiments, but the present invention is not limited to any embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention may not been described in detail.

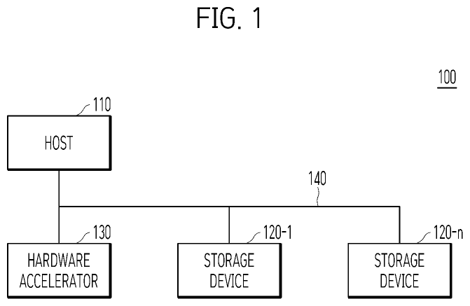

FIG. 1 illustrates a data processing system 100 in accordance with one embodiment of the present invention.

Referring to FIG. 1, the data processing system 100 may include a host 110, a plurality of storage devices 120-1 to 120-n and a hardware (HW) accelerator 130, which communicate over a bus 140, such as a Peripheral Component Interconnect Express (PCIe) bus. In one embodiment, the host 110 contains program code (software/firmware) for design (development), prototyping and evaluation of the HW accelerator 130.

The host 110, the hardware accelerator 130 and each of the plurality of storage devices 120-1 to 120-n may include a host controller, an accelerator engine and a storage device controller, respectively, to manage communication on the bus 140 and between the storage devices 120-1 to 120-n using a logical device interface protocol, such as the Non-Volatile Memory Express (NVMe) protocol or other suitable logical device interface protocols. Further, each of the host 110, the hardware accelerator 130 and each storage device 120-1 to 120-n may include a memory space. Each of the plurality of storage devices 120-1 to 120-n may further include storage regions such as NAND storage dies for a solid state drive (SSD), in which data is stored.

The host 110 may initialize and configure the plurality of the storage devices 120-1 to 120-n over the bus 140. After enumerating and initializing the plurality of the storage devices 120-1 to 120-n, the host 110 may configure the hardware accelerator 130, i.e., a memory space of the hardware accelerator 130. The memory space of the hardware accelerator 130 may be an extension of a memory space of the host 110. The memory space of the hardware accelerator 130 may provide an extension of the memory space of the host 110 to offload processing of the plurality of the storage devices 120-1 to 120-n, and read and write requests to the hardware accelerator 130. The memory space of the hardware accelerator 130 may be used to provide Direct Memory Access (DMA) transfers of data for read and write requests between the hardware accelerator 130 and the plurality of the storage devices 120-1 to 120-n. The DMA of the hardware accelerator 130 may bypass the host 110 to offload the management of the read and write for the plurality of the storage devices 120-1 to 120-n to the hardware accelerator 130.

The memory spaces of the host 110, the plurality of the storage devices 120-1 to 120-n and the hardware accelerator 130 may be implemented in one or more volatile memory devices or non-volatile memory devices. The controllers of the host 110 and the plurality of the storage devices 120-1 to 120-n and the accelerator engine of the hardware accelerator 130 may be implemented in firmware. The hardware accelerator 130 and the accelerator engine thereof may be implemented as a Field Programmable Gate Array (FPGA), Application Specific Integrated Circuit (ASIC) or other logics including programmable logics.

In some embodiments, the HW accelerator 130 may include graphics processing units (GPUs), digital signal processors (DSPs), and tensor processing units (TPUs), which are capable of performing one or more operations on the storage devices 120-1 to 120-n. The HW accelerator 130 may be designed or developed through the host 110.

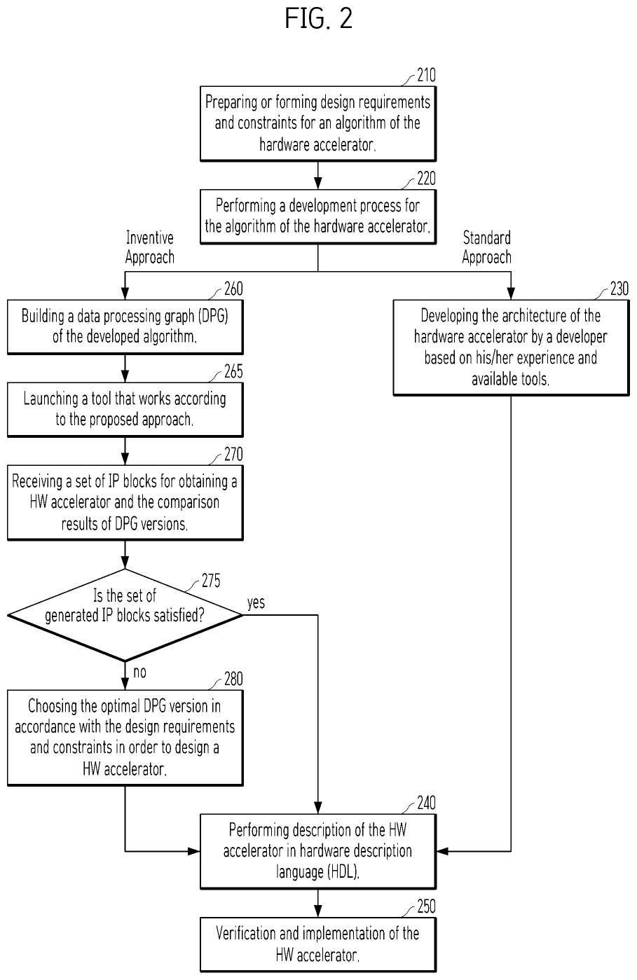

A design flow for a hardware (HW) accelerator 300 of FIG. 1 is shown in FIG. 2.

Referring to FIG. 2, a standard approach performs operations in order of 210, 220, 230, 240 and 250. 210 includes preparing or forming design requirements and constraints for an algorithm of the hardware accelerator. 220 includes performing a development process for the algorithm of the hardware accelerator. 230 includes developing the architecture of the hardware accelerator by a developer based on his/her experience and available tools. That is, with the standard approach, optimizing hardware costs and performance of the hardware accelerator is carried out by the developer or a group of developers based on their experience and skills.

Embodiments of the present invention provide a scheme or methodology in the design flow of the hardware accelerator capable of leading to cost reduction and/or performance improvement in the entire system design. Embodiments of the present invention for hardware accelerator development may use the approach or methodology disclosed below for the design of semiconductor devices such as system on a chip (SoC), where the role of one or more hardware accelerators is essential.

The inventive approach for rapid prototyping and evaluation of hardware accelerators utilizes in one embodiment the concept of a data processing graph (DPG) that describes the algorithm for operation of the hardware accelerator. In one embodiment, the DPG can be modified in order to improve the performance or reduce the hardware overhead of the hardware accelerator. One example of a DPG was described in Nahri Moreano et al., Efficient Datapath Merging for Partially Reconfigurable Architectures, IEEE Transactions on Computer-aided Design of Integrated Circuits and Systems, Vol. 24, No. 7, July 2005.

The inventive approach may analyze and make changes to the DPG of the original algorithm to generate multiple DPGs in order to reduce hardware costs and increase the speed of the designed hardware accelerator. The inventive methodology provides a way to perform prototyping and evaluation of HW accelerators using a given list of the available IP blocks. This methodology can analyze the results of applying changes to each version of DPG considering the design requirement and constraints. In electronic design, a semiconductor intellectual property core (SIP core), IP core, or IP block is a reusable unit of logic, cell, or integrated circuit layout design that is the intellectual property of one party. IP cores can be licensed to another party or owned and used by a single party. The term “SIP core” comes from the licensing of the patent or source code copyright that exists in the design. Designers of system on chip (SoC), application-specific integrated circuits (ASIC) and systems of field-programmable gate array (FPGA) logic can use IP cores as building blocks. In other words, depending on the used design tools, the developer has access to the different reusable hardware components (IP blocks) given by the hardware design libraries provider.

Referring back to FIG. 2, the inventive approach provides operations in order of 210, 220, 260, 265, 270, 275, 280, 240 and 250. These operations may be performed by a developer or a group of developers through the host 100 of FIG. 1.

The inventive approach replaces 230 of the standard approach with 260, 265, 270, 275 and 280. 260 includes building a data processing graph (DPG) of the developed algorithm. 265 includes launching a developer tool that works according to the inventive approach. 270 includes receiving a set of IP blocks for obtaining a HW accelerator and comparing results of different DPG versions. 275 includes determining whether the developer is satisfied with the set of generated IP blocks. If it is determined that the developer is satisfied with the set of generated IP blocks, 240 is performed. If it is determined that the developer is not satisfied with the set of generated IP blocks, 240 is performed after 280 is performed. 280 includes the developer choosing at least one optimal DPG version in accordance with the design requirements and constraints in order to design a HW accelerator. While there may be only one DPG version which is in theory the best, the present invention is not limited to selecting the best DPG version, but can select other optimal DPGs depending the characteristic that a developer is most concerned about. For example, one developer may be most concerned about hardware amount, another developer may be most concerned about operational speed, and another developer may be most concerned about power consumption. 240 includes providing description of the HW accelerator in hardware description language (HDL). 250 includes verification and implementation of the HW accelerator.

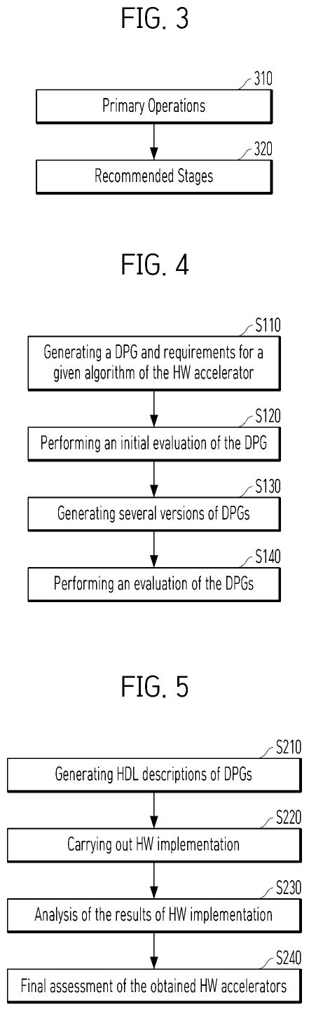

The inventive approach as shown in FIG. 2 can include primary operations (or mandatory operations) 310 and recommended stages 320 as shown in FIG. 3. The primary operations 310 correspond to 260, 265, 270, 275 and 280 of FIG. 2 and the recommended stages 320 correspond to 240 and 250 of FIG. 2.

The primary operations 310 obtains a DPG for a given algorithm of the HW accelerator and provides preliminary estimates of the performance and hardware overheads of the designed HW accelerator. The primary operations 310 can include operations (S110), (S120), (S130) and (S140) as shown in FIG. 4.

(S110) Generating a DPG and requirements and constraints for a given algorithm of the HW accelerator. The requirements and constraints may include performance, hardware overheads, and power consumption as described below.

The DPG may be used as a mathematical description of the hardware accelerator. At this stage, the developer may generate an initial graph that describes the algorithmic operation of the designed HW accelerator. In addition, the developer may form a list of available operations in the graph (nodes) and their parameters (complexity, functionally equivalent operations table).

In addition, the requirements (constraints) for the HW accelerator may be generated. In some embodiments, the requirements may include performance, hardware overhead and power consumption. As shown in List 1, performance may include values of latency and throughput, hardware overhead may include values of number of gates and number of memory elements such as flip-flops. The listed values affect the structure of the DPG, i.e., the number of levels and operations in the graph as shown in FIGS. 7 to 9.

### List 1:

| | |
|---|---|
| 1. | Performance: |
| | a. Latency |
| | b. Throughput |
| 2. | Hardware overhead: |
| | a. Number of gates |
| | b. Number of memory elements (e.g., flip-flops, |
| | SRAM arrays, etc.) |
| 3. | Power consumption. |

(S120) Performing an initial evaluation of the DPG.

The initial evaluation (assessment) involves an estimation of the complexity and performance of the DPG obtained at the previous stage S110. In some embodiments, the complexity estimation of the DPG may be carried out using the following metric:

### Graph Complexity Metric U:

$$U = {w}_{1} \times ( e - n + p ) + {w}_{2} \times ( {\sum }_{i = 0}^{M - 1} N ( i ) \times C ( i ) ) ,$$

where e represents the number of edges, n represents the number of nodes, p represents the number of connectivity components, i represents operation index, M represents the number of available operations, N(i) represents the number of times an i-th operation is used in the graph, C(i) represents a complexity level of the i-th operation, and w₁, w₂ represent weight coefficients which may be determined based on the importance of the graph structure (w₁) or complexity of the operations (w₂).

The complexity of the operation C(i) may be determined based on the specified requirements and constraints. For example, the complexity of the operation C(i) may be set in points on a scale from 1 to 10. The weight coefficients w₁, w₂ may influence the further choice of optimal graphs. The coefficient w₁ indicates an importance of the graph structure optimization, and the coefficient w₂ indicates the importance of the number and complexity of the operations within the graph.

In some embodiments, the performance estimation of the DPG may be carried out using the following metric:

### Performance Metric P:

$$P = 1 / ( L \times {\sum }_{i = 0}^{L - 1} K ( i ) ) ,$$

where L represents the number of levels in the graph, K(i) represents the maximal complexity among the operations at the i-th level.

(S130) Generating several versions of DPGs.

The initial DPG may be optimized and/or restructured (modified) based on the specified technical requirements (constraints). In one embodiment, those DPGs not compatible to the specified requirements and constraints would be eliminated.

At this stage, the process of optimizing the structure of the initial DPG obtained at S110 may be carried out. Optimization and minimization of the DPG may be performed in accordance with known algorithms, for example, an algorithm described in Jan Gosmann et al., Automatic Optimization of the Computation Graph in the Nengo Neural Network Simulator, Frontiers in Neuroinformatics, May 4, 2017. This stage can generate one or more graphs that satisfy one or more of the previously specified constraints, reduce hardware overhead and/or increase performance before integrating the initial DPG into the HW accelerator.

(S140) Performing an evaluation of the obtained DPGs. Among the obtained DPGs, the optimal graph may be selected based on the requirements and constraints, which can be done both automatically and/or by the developer. This stage performs a second evaluation of the obtained graphs at S130. The second evaluation may be carried out according to the same metrics at S120. Conducting a second evaluation provides a way to compare the obtained graphs with each other to choose the optimal graph based on the performance and/or hardware overhead requirements and constraints.

Referring back to FIG. 3, the recommended stages 320 may be included in the design flow to provide more accurate estimates of hardware and performance overheads. In one embodiment, the stages 320 described below are performed after the primary operations 310, because the results of the recommended stages depend on the previously obtained data (constraints, estimates, graphs).

The recommended stages 320 can include operations (S210), (S220), (S230) and (S240) as shown in FIG. 5.

(S210) Generating hardware description language (HDL) descriptions for the previously obtained DPGs automatically or manually.

In the case of automatic HDL generation, several HW parameters may be changed by the developer, i.e., the choice of HDL language, style and description rules, the structure of the resulting hardware accelerator according to the DPG (e.g., a single-cycle structure, microprogramming machine, state machine). At this stage, the HDL description of each of the DPGs is generated. The description can be built using the tools chosen by the developer to generate code in the required description language (e.g., VHDL, Verilog).

(S220) Carrying out the process of the HW implementation.

The process of the HW implementation in one embodiment involves the transformation of an HDL-files set into a list of used available blocks and connections between the blocks in the form of a netlist. HW implementation can be carried out both for application specific integrated circuits (ASIC) and for the field-programmable gate arrays (FPGA). The result of the HW implementation is a) the list of interconnections (netlist) and b) reports showing the used chip area, static timing analysis (STA), and power consumption.

(S230) Analysis of the results of HW implementation.

At this stage, the resulting HW accelerators are analyzed based on the data obtained at the previous stages. For example, the analysis parameters are the number of gates and memory elements used to place the accelerator on a chip, the maximum operating clock frequency, power consumption, etc. Analysis of the HW implementation results may be done by the processing of reports generated by the synthesis tool in order to extract the data of hardware overhead, maximum clock frequency on a chip, and power consumption. By having latency data of the obtained structures, it is possible to calculate the performance of the designed accelerator.

(S240) Final assessment of the obtained HW accelerators.

At this stage, the performance and hardware overhead are evaluated. For the analysis of the performance, the maximum throughput and latency of the obtained HW accelerators are estimated. For the analysis of the hardware overhead, the number of gates and memory elements are estimated. This data is considered for comparison of the DPGs with each other. Final assessment of the HW accelerators involves a comparison of the performance characteristics, hardware overhead and power consumption. Taking into account the constraints specified above and the parameters that are important for the developer, at least one optimal accelerator may be chosen out of the obtained structures. For example, the accelerator with the lowest power consumption or the highest performance may be selected.

### Example

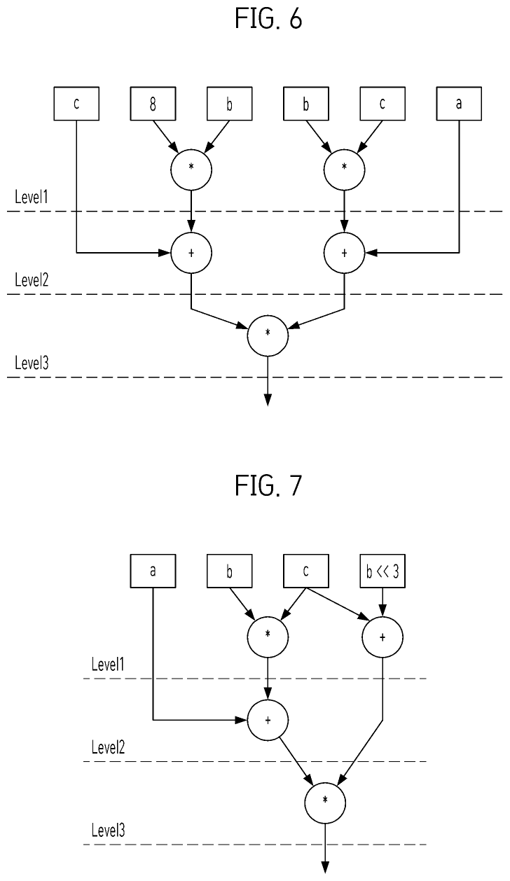

Consider an example of building a HW accelerator using the inventive methodology. A polynomial (8×b+c)×(a+b×c) may be implemented with the DPG shown in FIG. 6. FIG. 6 shows an initial graph of the computational process with index Id=1. This graph is built without restrictions on the number of levels and the number of operations at each level. In principle, the considered graph cannot be implemented with a smaller number of levels.

The original graph of FIG. 6 can be optimized. One possible optimization is to replace the operation of multiplication by constant to the equivalent shifting operation. The list of operations used in this example is shown in Table 1:

TABLE 1

| Operation | Symbol | Block complexity |
|---|---|---|
| Multiplication | * | 6 |
| Addition/Subtraction | +/− | 2 |
| Shifting left by a constant D | <<D | 1 |

The complexity of the operation may be determined by the developer's assessment based on the specified requirements and constraints. For example, the complexity can be estimated in points on a scale from 1 to 10. In this example, the level of complexity of the operations was chosen to reflect the complexity of its hardware implementation. For example, the operation of multiplication requires much more hardware resources for its implementation comparing to the addition operation. Since the shifting operation by a constant requires only interconnections for the implementation, it is considered as the simplest one.

For this example, it is assumed that the developer needs to get an accelerator with the lowest hardware overhead. To do this, the coefficients may be set as w₁=0.3, w₂=0.7, i.e., the number of used operations is more important than the performance (simple graph structure).

The estimation of the complexity (U) and performance (P) of the graph of FIG. 6 can be calculated as shown in List 2 using the graph complexity metric U and performance metric P noted above:

### List 2:

$$\begin{matrix}U = 0.3 \times ( 10 - 5 + 1 ) + 0.5 \times ( 2 \times 2 + 3 \times 6 ) = 0.3 \times 6 + 0.5 \times 22 = 12.8 \\ P = 1 / ( 3 \times ( 6 + 2 + 6 ) ) = 1 / 42 = 0.024\end{matrix}$$

The computation details for all graphs are summarized in Table 2 below.

The original graph (Id=1) of FIG. 6 can be modified using the following constraints: Maximum number of levels; and the number of operations used at each level.

By changing the original graph according to the requirements above, it can be reordered and modified to use only one adder and one multiplier at each level. The resulting modified graph (Id=2) is shown in FIG. 7.

The complexity (U) and performance (P) of the graph of FIG. 7 is estimated as shown in List 3:

### List 3:

$$\begin{matrix}U = 0.3 \times ( 8 - 4 + 1 ) + 0.5 \times ( 1 \times 1 + 2 \times 2 + 2 \times 6 ) = 0 \text{.3} \times 5 + 0.5 \times 17 = 10 \\ P = 1 / ( 3 \times ( 6 + 2 + 6 ) ) = 1 / 42 = 0.024\end{matrix}$$

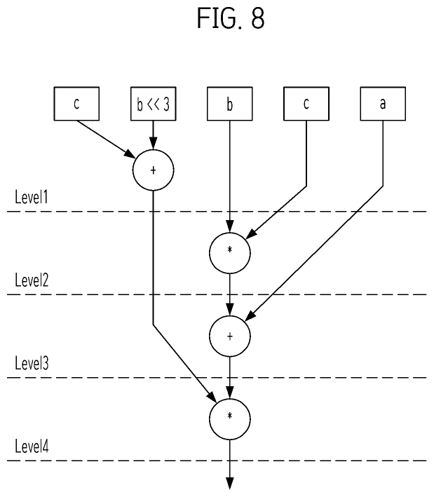

The graph with index Id=2 of FIG. 7 can be modified in accordance with the following constraints: it can use only one operation per level. The modified graph with index Id=3 is shown in FIG. 8.

The complexity (U) and performance (P) of the graph of FIG. 8 is computed as shown in List 4:

### List 4:

$$\begin{matrix}U = 0.3 \times ( 8 - 4 + 1 ) + 0.5 \times ( 1 \times 1 + 2 \times 2 + 2 \times 6 ) = 0.3 \times 6 + 0 \text{.5} \times 17 = 10 \\ P = 1 / ( 4 \times ( 2 + 6 + 2 + 6 ) ) = 1 / 64 = 0.024\end{matrix}$$

The obtained estimations of the complexity and performance make it possible to assess the hardware overhead and performance of HW accelerators design without carrying out HW implementation. The comparison of the estimated metrics for the considered graphs in FIGS. 6 to 8 are summarized shown in Table 2:

TABLE 2

| Graph Id | 1 (FIG. 6) | 2 (FIG. 7) | 3 (FIG. 8) |
|---|---|---|---|
| e | 10 | 8 | 8 |
| n | 5 | 4 | 4 |
| p | 1 | 1 | 1 |
| N {<<} | 0 | 1 | 1 |
| N {+} | 2 | 2 | 2 |
| N {*} | 3 | 2 | 2 |
| U | 12.8 | 10.0 | 10.0 |
| P | 0.024 | 0.024 | 0.016 |

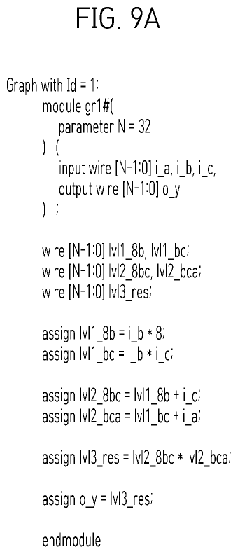

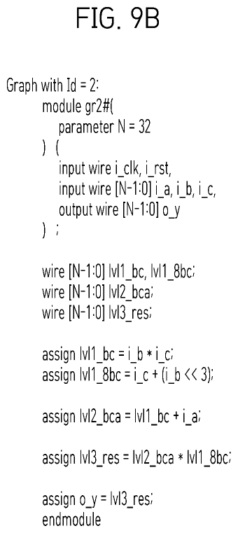

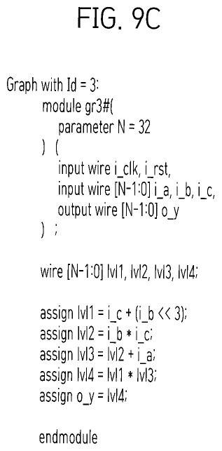

To experimentally verify the estimations, the HW implementation for all three graphs may be carried out. The HDL descriptions (Listings 1-3) corresponding to the obtained graphs of FIGS. 6 to 8 are shown in FIGS. 9A to 9C, respectively. It should be noted that the description may be generated by the developer and by automation tools.

### Technological Synthesis:

In some embodiments, the HW implementation has been performed for the Xilinx Atrix-7 FPGA chip, which is described in page 3 of 7 Series Product Selection Guide (XMP101), v1.8, Apr. 8, 2021, Xilinx. The synthesis has been carried out in CAD Vivado, which is described in Vivado Design Suite User Guide: Release Notes, Installation, and Licensing (UG973) (v2020.2), Feb. 3, 2021, Xilinx.

As a result of the synthesis process, the following information about hardware costs and performance of hardware accelerators was generated based on previously obtained graphs shown in Table 3:

TABLE 3

| Resource\Graph Id | 1 | 2 | 3 |
|---|---|---|---|
| Look Up Tables | 1429 | 1297 | 1153 |
| Max freq, MHz | 62.528 | 65.931 | 47.650 |

The hardware overhead for the original graph is maximal due to its complexity (see metric value in Table 2). Based on the aforementioned requirement for building a HW accelerator with minimal hardware overhead, the developer may choose a graph with Id=3, but in this case, the performance of the accelerator will be lower than in the other options. If the main requirement for the accelerator is performance, the best option is to build an accelerator based on a graph with Id=2.

By comparing Tables 2 and 3, the graph complexity metric is highly correlated with hardware costs for implementing a HW accelerator (Look Up Tables), and the performance metric is also correlated with the maximum clock frequency of the accelerator design.

Based on the results of HW implementation, the application of the inventive methodology for the initial DPG (FIG. 6) provides a way to make changes to its structure in order to increase performance and/or reduce hardware overhead for its implementation in a digital integrated circuit. The inventive methodology also evaluates the complexity and performance of the resulting hardware accelerators before carrying out HW implementation, which potentially saves valuable human resources for the HW accelerators development.

As described above, embodiments of the present invention provide a scheme for rapid prototyping and evaluation of HW accelerators, which in one embodiment can be implemented in the design flow for the systems on a chip. The scheme assesses the performance and complexity of the resulting HW accelerators before conducting HW implementation, which speeds up the development process and reduces the overheads for the design process.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives. Furthermore, the embodiments may be combined to form additional embodiments.

What is claimed is:

1. A method for evaluating a hardware accelerator, the method comprising:
generating a data processing graph for describing at least one algorithmic operation;
evaluating a complexity and performance of the data processing graph using complexity and performance metrics;
modifying the data processing graph based on set constraints, and the evaluated complexity and performance to generate multiple data processing graphs;
evaluating the multiple data processing graphs using the complexity and performance metrics; and
selecting at least one optimal graph from among the multiple data processing graphs for design of the hardware accelerator.

2. The method of claim 1, wherein the evaluating the multiple data processing graphs comprises evaluating for the set constraints at least one or more of performance characteristics, hardware overhead and power consumption.

3. The method of claim 1, wherein the evaluating a complexity and performance of the data processing graph comprises determining the complexity metric based on one or more of a number of edges, a number of nodes, a number of connectivity components, an operation index, a number of available operations, a number of times an operation is used in the data processing graph, a complexity level of the operation, and weight coefficients.

4. The method of claim 3, wherein the weight coefficients used in determining the complexity metric include a first coefficient for indicating an importance of the graph structure optimization, and a second coefficient for the importance of the number and complexity of the operations within the data processing graph.

5. The method of claim 3, wherein the evaluating a complexity and performance of the data processing graph comprises determining the performance metric based on a number of levels in the data processing graph and at least one maximal complexity among the operations at the levels.

6. The method of claim 1, wherein the modifying the data processing graph to generate multiple data processing graphs provide graphs that satisfy the set constraints, reduce the evaluated complexity and increase the evaluated performance.

7. The method of claim 1, wherein the optimal graph selected comprises a graph with the highest performance and the lowest power consumption from among the multiple data processing graphs.

8. The method of claim 1, further comprising:
generating hardware description language (HDL) descriptions of the multiple data processing graphs.

9. The method of claim 8, further comprising:
implementing a hardware based on the HDL descriptions.

10. The method of claim 9, further comprising:
analyzing the implementation results of the hardware.

11. A system comprising:
a host configured for hardware accelerator development;
a storage device; and
a hardware accelerator designable by the host and coupled between the host and the storage device,
wherein the storage device is configured to store data associated with a calculated performance of the hardware accelerator,
wherein the host is configured to:
generate a data processing graph for describing at least one algorithmic operation;
evaluate a complexity and performance of the data processing graph using complexity and performance metrics;
modify the data processing graph based on set constraints, and the evaluated complexity and performance to generate multiple data processing graphs; and
evaluate the multiple data processing graphs using the complexity and performance metrics to select at least one optimal graph from among the multiple data processing graphs for design of the hardware accelerator.

12. The system of claim 11, wherein the set constraints include performance characteristics, hardware overhead and power consumption.

13. The system of claim 11, wherein the complexity metric is determined based on a number of edges, a number of nodes, a number of connectivity components, an operation index, a number of available operations, a number of times the operation is used in the data processing graph, a complexity level of the operation, and weight coefficients.

14. The system of claim 13, wherein the weight coefficients include a first coefficient for indicating an importance of the graph structure optimization, and a second coefficient for the importance of the number and complexity of the operations within the data processing graph.

15. The system of claim 13, wherein the performance metric is determined based on a number of levels in the data processing graph and at least one maximal complexity among the operations at the levels

16. The system of claim 11, wherein the multiple data processing graphs include graphs that satisfy the set constraints, reduce the evaluated complexity and increase the evaluated performance.

17. The system of claim 11, wherein the optimal graph selected comprises a graph with the highest performance and the lowest power consumption from among the multiple data processing graphs.

18. The system of claim 11, wherein the host is further configured to generate hardware description language (HDL) descriptions of the multiple data processing graphs.

19. The system of claim 18, wherein the hardware accelerator comprises hardware based on the HDL descriptions.

20. The system of claim 19, wherein the host is further configured to analyze implementation results of the hardware.
